(19) United States
(12) Patent Application Publication
(10) Pub. No.: US 2023/0298419 A1
(43) Pub. Date: Sep. 21, 2023

(54) DOOR ALARM SYSTEM AND METHOD FOR CONTROLLING SAME

(71) Applicant: Thomas Buchhalter, Niederkassel (DE)

(72) Inventor: Thomas Buchhalter, Niederkassel (DE)

(21) Appl. No.: 18/122,454

(22) Filed: Mar. 16, 2023

(30) Foreign Application Priority Data
Mar. 16, 2022 (DE) 10 2022 106 109.4

(51) Int. Cl. G07C 9/28; G08B 21/18

(52) U.S. Cl. CPC G07C 9/28; G08B 21/18

(57) ABSTRACT

A door alarm system with a housing, which can be fastened to the inside of a door, with an alarm device, an activation/deactivation switch device, and a door opening sensor, wherein the activation/deactivation switch device includes a radio receiver with at least one associated portable transmitter for switching the activation/deactivation switch device to the deactivated state by a corresponding radio signal, wherein the activation/deactivation switch device includes a proximity sensor for detecting a person approaching the housing and is configured so that when a person is detected, the activation/deactivation switch device can be switched to the deactivated state. A method for controlling a door alarm system is also disclosed.

### CROSS REFERENCE TO RELATED APPLICATION

German Patent Reference DE 10 2022 106 109.4, filed 16 Mar. 2022, the priority document corresponding to this invention, to which a foreign priority benefit is claimed under Title 35, United States Code, Section 119, and its entire teachings are incorporated, by reference, into this specification.

### BACKGROUND OF THE INVENTION

### Field of the Invention

This invention relates to a door alarm system with a housing, which can be fastened to the inside of a door, with an alarm device, an activation/deactivation switch device, and a door opening sensor, wherein the activation/deactivation switch device includes a radio receiver with at least one associated portable transmitter for switching the activation/deactivation switch device to the deactivated state by a corresponding radio signal.

This invention also relates to a method for controlling a door alarm system, which is positioned on the inside of a door and has an alarm device, an activation/deactivation switch device, and a door opening sensor, wherein the activation/deactivation switch device with at least one radio receiver and at least one associated portable transmitter is switched to the deactivated state by a corresponding radio signal.

### Discussion of Related Art

Door alarm systems of the type mentioned above are known and are used in connection with both the initial installation and upgrading of house and apartment doors in order to secure them against unauthorized opening, for example, in the context of an attempted burglary.

Such a door alarm system is usually mounted on the inside, such as facing the inside of the house or apartment, on or next to the entry door. For this purpose, the housing is placed, for example, in a corresponding recess, such as in the door panel, or is firmly mounted, such as glued, to the door or its door frame. After the activation/deactivation switch device is switched to the activated state, such as when leaving the apartment, the door alarm system monitors the entry door by the door opening sensor and in the activated state, issues the alarm by the alarm device as soon as the entry door is opened. In order to be able to open the entry door without triggering the alarm, such as when the authorized persons return, one or more portable transmitters for authorized persons are provided, which transmit a corresponding radio signal to the radio receiver in order to switch the activation/deactivation switch device to the deactivated state before, during, or within a short predefinable time interval after the opening of the door and to suppress the triggering of the alarm.

In the previously known door alarm systems of the type mentioned above, it is disadvantageous that they always have to be actively switched between the activated and deactivated states in order to be able to perform their monitoring and alarm functions. In this connection, a user must always remember to activate the door alarm system when leaving the house or apartment. On the other hand, an activated door alarm system involves the danger of triggering a false alarm, for example, when someone returns and forgets to deactivate the door alarm system again before opening the door. The additional procedures that must be performed for the activation and deactivation, particularly for untrained or inexperienced persons, necessarily entail a high risk of incorrect operation and an undesirably high degree of operational complexity.

### SUMMARY OF THE INVENTION

One object of this invention is to provide a door alarm system and a method for controlling a door alarm system, which overcome the disadvantages of the prior art and provide a door alarm system that is particularly simple and reliable to operate with a high level of security.

To attain the stated object and other objects, this invention provides for a door alarm system to be embodied according to the features described in this specification and in the claims.

According to this invention, a door alarm system is provided in which the activation/deactivation switch device includes a proximity sensor for detecting a person approaching the housing and is configured so that when a person is detected, the activation/deactivation switch device can be switched to the deactivated state.

Since the door alarm system according to this invention is mounted on the inside of the door to be monitored, the door alarm system can therefore be activated in the basic state, even if a person is inside the thus-secured apartment. An opening of the door from the inside thus reliably does not result in a triggering of the alarm since the opening of the door from the inside always presupposes that a person approaches the door from the inside. This basically authorized approach of the person prior to the opening of the door is reliably detected by the proximity sensor that is provided according to this invention, which then immediately switches the activation/deactivation switch device of the door alarm system according to this invention to the deactivated state. This therefore prevents a false alarm due to an operating error.

Independent of the above-mentioned activation/deactivation of the alarm system from the inside, when the monitored door is approached from the outside, the activation/deactivation switch device of the door alarm system is deactivated in the intrinsically known way by a radio signal from the portable transmitter to the radio receiver in order to be able to open the door without triggering the alarm.

According to one embodiment of this invention, the proximity sensor is embodied in the form of a pyroelectric sensor, in particular a passive infrared motion sensor (PIR sensor) of the kind widely and successfully used in building technology, such as in the form of a motion sensor.

To further increase the reliability and ease of use, it is proposed for the activation/deactivation switch device to be configured so that it can be switched to the activated state when the door opening sensor detects a closed door. This ensures that the door opening sensor automatically and immediately activates the door alarm system according to this invention as soon as the monitored door is closed or reclosed. In this respect, it is not necessary and thus difficult to forget, to activate the door alarm system according to this invention in order to achieve its security function. A door alarm system that has been switched to the deactivated state, for example, by the proximity sensor or the radio receiver, is automatically switched back into the activated state as soon as the monitored door is reclosed.

In this connection, in order to ensure that the automatic activation is carried out only when the door is completely closed, according to one embodiment of this invention, the door alarm system according to this invention can also be enhanced with a mechanical spring, such as made of metal or plastic, or a pair of magnets, which are positioned between the door frame and door so that when the door is not completely closed, they push it open again far enough that the door opening sensor reliably does not signal a closed door and therefore, the automatic activation does not occur. Only with a completely closed door, such as with the door lock latched, is the restoring force of the spring or the pair of magnets that repel each other overcome, whereupon the door opening sensor signals a closed door, which triggers the automatic activation of the door alai system according to this invention.

According to one embodiment of this invention, the radio receiver is configured in such a way that it can be switched on when the door opening sensor detects an open door. In this way, the radio receiver, as a component of the door alarm system according to this invention, can be operated with a significantly reduced energy consumption because it is activated only if the door opening sensor detects a door opening and at that moment, the receiving function of the radio receiver is required for the reception of a radio signal from the radio transmitter and the corresponding deactivation. Such a design is particularly advantageous if the door alarm system according to this invention is subsequently mounted as an upgrade solution on a door that is to be monitored and for this purpose, has batteries for supplying operating voltage accommodated in the housing.

Likewise, the at least one transmitter, which authorized persons can carry on a key ring for example, can also, in order to extend the service life of an integrated battery, have a motion sensor that activates the transmitter when a motion is detected and when not in operation, such as when the set of keys is not being used, switches off the transmitting function in order to conserve the battery. If an authorized person approaches from the outside and unlocks the monitored door, then during this procedure, the transmitter is activated. Once the door opens, the radio receiver, controlled by the door opening sensor, is also activated, receives the radio signal of the transmitter, and switches the activation/deactivation switch device of the door alarm system according to this invention into the deactivated state.

This procedure can be facilitated by the fact that between the opening of the door and the triggering of the alarm, a short defined time interval of for example up to 2 seconds remains, within which the activation of the radio receiver and the switch to the deactivated state can be carried out without the alarm being triggered.

The radio signal that is sent between the at least one transmitter and the radio receiver can, for example, conform to the Bluetooth radio protocol.

According to one embodiment of this invention, the door opening sensor can be embodied as a magnetic field sensor and can cooperate with an associated magnet. If the door alarm system according to this invention is mounted to the inside of the door panel, then the associated magnet is fastened to the door frame at a suitable position in which when the door is closed, it is positioned in the immediate vicinity of the door alarm system. For example, such a magnet can be equipped to be adhesive. As soon as the door is opened, the magnetic flux changes due to the increase in the distance from the door alarm system, which can be reliably detected by the door opening sensor in the housing of the door alarm system according to this invention.

Naturally, the reverse arrangement can also be provided in connection with this invention, such as the door alarm system can be fastened to the door frame in stationary fashion and to that end, the magnet can be fastened adjacent to it on the door panel.

According to one embodiment of this invention, at least one spring and/or a pair of magnets that repel each other can be provided, which are provided for being mounted on the door or on a door frame associated with the door. The at least one spring or the pair of magnets that repel each other ensures that a door that is not completely closed and locked is moved back into the open position so that the door opening sensor registers a door opening, prevents the activation of the alarm system in this state, and signals that the door is open, such as by a suitable display or a message sent to a smart home system.

As an alarm device, the door alarm system according to this invention can, in an intrinsically known way, have a siren, which in the event that the alarm is triggered, outputs a clearly audible acoustic alarm signal. Furthermore, alternatively or in addition, an interface to a smart home system or a home automation system can, for example, have a ZigBee radio transceiver in order, in addition to alarm notices, to also send the system messages about the status of the door alarm system such as activation or deactivation, door open or closed, and the state of the batteries and to incorporate them into a smart home environment. In addition, a GSM interface can be provided for calling and notifying appointed persons or organizations in the event that an alarm is triggered.

In addition to the door opening sensor, the door alarm system according to this invention can also have other sensors such as vibration sensors in order, in the activated state, to be able to reliably detect an attempted burglary and trigger an alarm.

The power supply of the alarm system can be assured by an integrated rechargeable battery, which can be charged as needed, for example, by a charging cable or a mobile power pack.

The method according to this invention for controlling a door alarm system is based on the fact that the door alarm system is positioned on the inside of a door, which is to be monitored, and has an alarm device, an activation/deactivation switch device, and a door opening sensor, wherein the activation/deactivation switch device with at least one radio receiver and at least one associated portable transmitter is switched to the deactivated state by a corresponding radio signal.

In order to enable an automatic and autonomous switching of the door alarm system from the activated state into the deactivated state, for example, when a person on the inside wishes to open the door, it is proposed for the activation/deactivation switch device to include a proximity sensor for detecting a person approaching the housing and when a person is detected, the activation/deactivation switch device is switched to the deactivated state. The deactivation therefore occurs without any action by the person as soon as he or she approaches the door alarm system in a legitimate way in the region of or near the interior that is closed by the door.

According to one embodiment of this invention, in addition, the activation/deactivation switch device is switched into the activated state when the door opening sensor detects a closed door. The method according to this invention is thus designed so that with each closing of the door, the door alarm system is activated in order to achieve maximum security. This activation also occurs automatically without any action by the person, as soon as the door is closed.

In addition to the automatic deactivation that has already been explained above when the approach of a person in the region of the inside is detected by the proximity sensor, an autonomous and automatic deactivation can be provided by the radio receiver and the associated portable transmitter, which an authorized person carries on a set of keys, for example.

According to one embodiment of this invention, in this connection, the radio receiver is switched on when the door opening sensor detects an open door. This minimizes the energy consumption of the radio receiver because it is only activated at the time when the reception of a radio signal is required for switching to the deactivated state. In order to save energy, the transmitter can also be equipped with a motion sensor for activating its transmitting function only when motion is detected. If the transmitter is attached, for example, to a set of keys, it correspondingly switches on when the door is opened.

### BRIEF DESCRIPTION OF THE DRAWINGS

Other embodiments and details of this invention will be explained in greater detail below in view of an exemplary embodiment shown in the figures, wherein:

FIG. 1 shows a front view of a door alarm system according to this invention; and

FIG. 2 shows the sequence of a control of the door alarm system according to this invention.

### DETAILED DESCRIPTION OF THE INVENTION

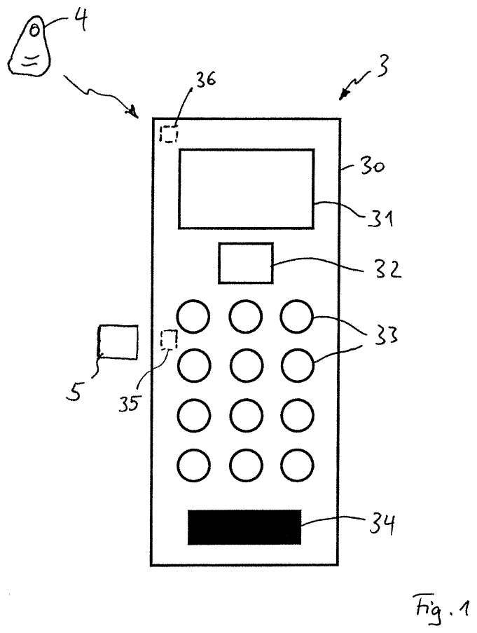

FIG. 1 shows a door alarm system, which is used to monitor entry doors of houses or apartments.

The door alarm system comprises a housing 3 that is mounted in the region of or near the inside of a door that is not shown, with a display 31 mounted in the region of the visible side and a keypad with a plurality of keys 33 for configuring various operating states and settings. In addition, the door alarm system comprises at least one radio transmitter 4, which is embodied as portable and can be embodied, for example, in the form of a key fob, as well as a magnet 5, which is embodied as adhesive, for example. The transmitter 4 and magnet 5 are embodied as separate from the housing 3.

In a manner that is not shown in detail, in order to monitor a door, the housing 3 is inserted, for example, into a corresponding recess in the door panel, particularly when it is first installed, or positioned on the door panel, particularly when upgrading the door with a door alarm system. For this purpose, the housing 3 can be embodied with an adhesive glue strip on the bottom side opposite from the depicted visible side. The magnet 5 is likewise affixed in stationary fashion, such as glued, adjacent to the housing 3, for example, on the door frame of the door that is to be monitored.

Inside the housing 3, an activation/deactivation switch device that is not shown in detail is provided, which communicates among other things with a radio receiver 36 and a door opening sensor 35 that are both integrated into the housing 3. In addition, the activation/deactivation switch device communicates with a proximity sensor 32 that is integrated into the front side of the housing 3 and that can be embodied in the form of a PIR sensor, for example, and detects when a person is approaching.

Finally, the housing 3 also has an alarm device 34 in the form of a siren, which can also be supplemented, for example, by a GSM module or an interface with a smart home system and has a rechargeable battery for supplying operating voltage.

The door opening sensor 35 is embodied as a magnetic field sensor for detecting the magnetic field of the magnet 5 and indicating changes in this magnetic field. If in an installation position with a closed door, the magnet 5 and the housing 3 come to rest next to each other as schematically depicted in FIG. 1, the door opening sensor 35 registers a corresponding magnetic field that should be saved upon initial installation of the door alarm system. As soon as the door is opened, the distance between the magnet 5 and the door opening sensor 35 increases and the magnetic field measured by the door opening sensor 35 decreases accordingly so that the door opening sensor 35 can reliably register the opening of the door and can announce this to the activation/deactivation switch device by a corresponding signal. If in addition, the door alarm system is enhanced with a small spring, which is fastened, such as glued, to the door frame, for example, in the region of or near the door overlap, then this spring ensures that an incorrectly closed door always springs back into its open position, which the door alarm system can report to a smart home system, for example, via the interface and in addition, in the way that will be described in greater detail below, ensures an activation of the door alarm system only with a correctly closed door. Instead of such a spring, a pair of magnets that repel each other can also be provided.

The radio receiver 36 inside the housing 3 is configured so that it can receive a correspondingly encoded radio signal from the transmitter 4 or from a plurality of such transmitters 4 and, for example, can report the receipt of such an authenticated radio signal to the activation/deactivation switch device by a corresponding signal. For this purpose, a plurality of, for example up to 12, such transmitters 4 can be trained to work with the door alarm system and function in accordance with an established radio protocol, for example the Bluetooth radio protocol.

The display 31, which is embodied, for example, as an OLED display, and the keypad 33 are activated only when needed in order to reduce the current consumption of the door alarm system, which can be powered, for example, by the batteries or rechargeable cells, which are not shown here and are accommodated in the housing 3, or can also be supplied with operating voltage by an external power supply unit.

The transmitters 4 also have an internal voltage supply, for example, provided by button cells, and can be operated over suitably long time intervals. In addition, in order to extend battery life, they can be equipped with a motion sensor, which activates the transmitting function of the transmitter 4 for a short predefinable time interval only when there is a movement of the transmitter 4, for example, when it is fastened to a set of keys, when the key is actuated in order to open the door. But if the transmitter 4 is at rest, then no signal is transmitted. With such a control, it is possible to achieve battery life durations of several years.

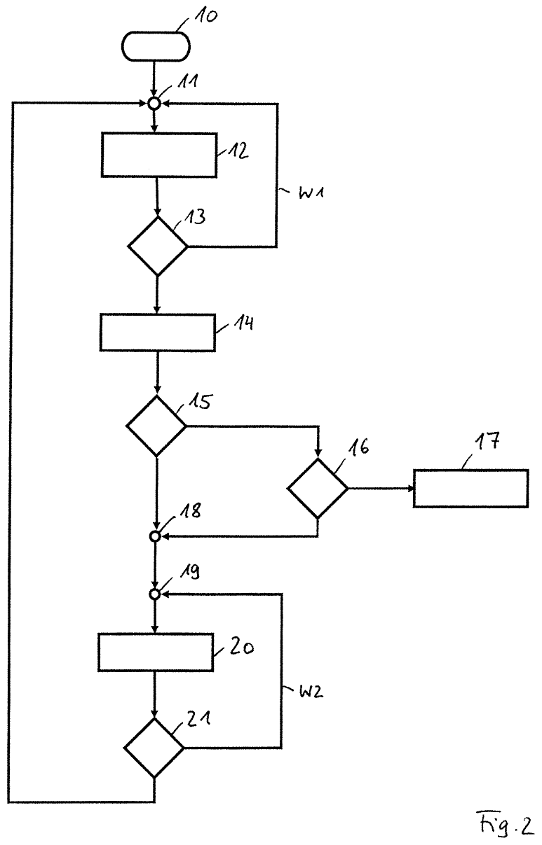

An essential feature of the described door alarm system is that after its initial operation and configuration, it requires no further operation by the persons who are authorized to pass through the monitored door. Instead, the door alarm system enables a control that does not require action by the authorized persons and enables a reliable monitoring of the door that is equipped and secured in this way. This functionality will be explained in greater detail below in conjunction with the flowchart shown in FIG. 2.

After an initial operation and configuration for example of the measured magnetic field of the magnet 5 and training of the transmitters 4 and possibly also integration into a smart home system and storage of an emergency number for the GSM module in step 10, after the sequence passes through the connecting node 11, the door alarm system is activated in step 12 by the activation/deactivation switch device, such as the door alarm system is always activated in the basic state.

In this activated basic state, in order to reduce the power consumption, the display 31 and the radio receiver 36 of the housing 3 are deactivated, but both the door opening sensor 35 and the proximity sensor 32 are active.

In step 13, the door alarm system is therefore in the activated state and monitors the opening state of the door. As long as the door opening sensor 35 does not signal an opening of the door, the door alarm system remains in an activated waiting loop between the steps 11, 12, and 13, which is shown with the aid of the repeat loop W 1 in FIG. 2.

If the door opening sensor 35 registers a door opening, then the radio receiver 36 is immediately activated in step 14. At the same time, in step 15, a check is also performed as to whether the proximity sensor 32 detects a person in the region of or near the inside of the door alarm system 3 shown in FIG. 1.

The event of an open door detected by the door opening sensor 35 can have three different causes.

The first cause includes the fact that a person, who is inside the space such as a house or apartment that is closed by the monitored door, has approached a door adjacent to him or her and opens it. In this case, the person is detected by the proximity sensor 32.

The second cause includes the fact that a person opens this door from the outside in a legitimate, authorized way because the person has the required key and a radio transmitter 4. In this case, the activated radio receiver 36 receives a corresponding signal from the transmitter 4. For example, up to twenty such radio transmitters can be connected to the door alarm system in order to grant access to a corresponding number of authorized persons.

The third cause includes an unauthorized opening of the door, in particular an attempted burglary. In this case, neither the proximity sensor 32 nor the radio receiver 36 detects the presence of an authorized person and as a result, an alarm is triggered.

These 3 different causes are indicated as follows in the wiring and control schematic according to FIG. 2.

If a person is detected by the proximity sensor 32, then from step 15, the sequence skips over the connecting nodes 18 and 19 to step 20 and the door alarm system is switched to the deactivated state in order to correspondingly prevent the first cause of a triggering of the alarm.

But if no person is detected by the proximity sensor 32, then in step 16 a test is performed as to whether the radio receiver 36 is receiving a signal of a transmitter 4. If this is the case, then from step 16, the sequence skips to the connecting node 18 and from there over the connecting node 19 to step 20 in which the door alarm system is switched to the deactivated state, which corresponds to the second cause.

But if the radio receiver 36 is not receiving a radio signal in step 16, then this indicates the existence of the third cause, namely an attempted burglary and in step 17, the alarm device 34 is activated.

In those cases in which, because of an authorized, legitimate opening of the door, the door alarm system has been switched to the deactivated state in step 20, a test is them performed by the door opening sensor 35 as to whether the door has been correctly closed again. If this is not the case, then the sequence returns in the repeat loop W2 to the connecting node 19 and the door alarm system remains in the deactivated state in step 20.

But if the door has been correctly reclosed and the corresponding signal of the door opening sensor 35 is reported back because the magnetic field of the magnet 5 has been detected, then the sequence returns to the connecting node 11 and from there, proceeds to step 12 in which the door alarm system is switched back into the activated state.

A small mechanical spring and/or a pair of magnets that repel each other mounted between the door and door frame ensures that the door must be correctly and completely closed before the switch back to the activated state is carried out. If the door is not completely closed, such as has not latched in the door lock, then the spring or the pair of magnets pushes the unlatched door open again far enough that a magnetic field that indicates the correct closing of the door is not detected by the door opening sensor 35 and the door alarm system remains in the deactivated state in step 20. This reliably prevents a false alarm due to an incompletely closed door.

The above-explained activation and deactivation are each performed through a corresponding triggering of the activation/deactivation switch device by the proximity sensor 32, the door opening transmitter 35, and/or the radio receiver 36 in the above-described way.

The detection by the proximity sensor 32 of an approaching person can, as in the presented exemplary embodiment according to FIG. 2, come after the detection of the door opening and activation of the radio receiver 36 in steps 13 and 14 or can also be executed in parallel with them in order, when a person is detected by the proximity sensor 32 to immediately switch the door alarm system into the deactivated state according to step 20.

It is clear from the foregoing that after the initial operation, the door alarm system requires no further operation effort and instead, when an authorized door opening from the inside or outside occurs, the system briefly switches to the deactivated state and after the door is closed again, the system automatically switches back into the activated state, without a person having to actively carry out an activation or deactivation. The activation or deactivation of the door alarm system therefore cannot be forgotten and lead to a false alarm or to a failure to secure the door.

Furthermore, the by-default activated state of the door alarm system and the immediate triggering of the alarm when an unauthorized opening of the door occurs ensure a particularly high level of security.

With such a door alarm system, it is thus possible to completely secure entry doors of apartments on the second floor and higher since at this height and above, the only access to the apartment is through the entry door.

Naturally, the housing 3 can also be embodied with an agitation sensor, vibration sensor, or the like in order, for example, to detect a forcible breaking-open of the door and immediately trigger an alarm.

Since the above-explained door alarm system does not require any additional operating steps when opening or closing the monitored door, it requires only minimal effort, namely once upon initial operation. It is therefore particularly suitable for use by children or older people since they do not have to familiarize themselves with any additional work steps for activation or deactivation.

While in the foregoing specification this invention has been described in relation to certain preferred embodiments, and many details are set forth for purpose of illustration, it will be apparent to those skilled in the art that this invention is susceptible to additional embodiments and that certain of the details described in this specification and in the claims can be varied considerably without departing from the basic principles of this invention.

1. A door alarm system with a housing (3), which can be fastened to an inside of a door, with an alarm device (34), an activation/deactivation switch device, and a door opening sensor (35), wherein the activation/deactivation switch device includes a radio receiver (36) with at least one associated portable transmitter (4) for switching the activation/deactivation switch device to a deactivated state by a corresponding radio signal, the door alarm system comprising the activation/deactivation switch device including a proximity sensor (32) for detecting a person approaching the housing (3) and configured so that when a person is detected, the activation/deactivation switch device can be switched to the deactivated state.

2. The door alarm system according to claim 1, wherein the proximity sensor (32) is embodied in the form of a pyroelectric sensor.

3. The door alarm system according to claim 2, wherein the activation/deactivation switch device is configured so that it can be switched to the activated state when the door opening sensor (35) detects a closed door.

4. The door alarm system according to claim 3, wherein it also includes at least one spring and/or a pair of magnets that repel each other, which are provided for being mounted on the door or on a door frame associated with the door.

5. The door alarm system according to claim 4, wherein the radio receiver (36) is configured so that it can be switched on when the door opening sensor (35) detects an open door.

6. The door alarm system according to claim 5, wherein the at least one transmitter (4) has a movement sensor and can be activated when the movement sensor detects a movement.

7. The door alarm system according to claim 6, wherein the door opening sensor (35) is embodied as a magnetic field sensor and has an associated magnet (5).

8. The door alarm system according to claim 7, wherein the alarm device (34) includes a siren and/or an interface to a home automation system.

9. A method for controlling a door alarm system, which is positioned on an inside of a door and has an alarm device (34), an activation/deactivation switch device, and a door opening sensor (35), wherein the activation/deactivation switch device with at least one radio receiver (36) and at least one associated portable transmitter (4) is switched to a deactivated state by a corresponding radio signal, the method including the activation/deactivation switch device including a proximity sensor (32) for detecting a person approaching the housing (3) and when a person is detected, the activation/deactivation switch device being switched to the deactivated state.

10. The method according to claim 9, wherein when the door opening sensor (35) detects a closed door, the activation/deactivation switch device is switched to the activated state.

11. The method according to claim 10, wherein the radio receiver (36) is switched on when the door opening sensor (35) detects an open door.

12. The method according to claim 9, wherein the radio receiver (36) is switched on when the door opening sensor (35) detects an open door.

13. The door alarm system according to claim 1, wherein the activation/deactivation switch device is configured so that it can be switched to the activated state when the door opening sensor (35) detects a closed door.

14. The door alarm system according to claim 1, wherein it also includes at least one spring and/or a pair of magnets that repel each other, which are provided for being mounted on the door or on a door frame associated with the door.

15. The door alarm system according to claim 1, wherein the radio receiver (36) is configured so that it can be switched on when the door opening sensor (35) detects an open door.

16. The door alarm system according to claim 1, wherein the at least one transmitter (4) has a movement sensor and can be activated when the movement sensor detects a movement.

17. The door alarm system according to claim 1, wherein the door opening sensor (35) is embodied as a magnetic field sensor and has an associated magnet (5).

18. The door alarm system according to claim 1, wherein the alarm device (34) includes a siren and/or an interface to a home automation system.
